(19) United States
(12) Patent Application Publication
(10) Pub. No.: US 2023/0331107 A1
(43) Pub. Date: Oct. 19, 2023

(54) AUTOMATIC CHARGING DEVICE AND ROLLER-TABLE PARKING EQUIPMENT

(71) Applicant: HANGZHOU DAZHONG BOAO TECHNOLOGY CO., LTD., Hangzhou City (CN)

(72) Inventors: Yanzheng WU, Hangzhou City (CN); Shuilong ZHENG, Hangzhou City (CN)

(21) Appl. No.: 18/141,732

(22) Filed: May 1, 2023

Related U.S. Application Data
(63) Continuation of application No. PCT/CN2022/089431, filed on Apr. 27, 2022.

(30) Foreign Application Priority Data
Apr. 13, 2022 (CN) 202210383456.5

(51) Int. Cl. B60L 53/35; B60L 53/18; B60L 53/16

(52) U.S. Cl. CPC B60L 53/35; B60L 53/18; B60L 53/16

(57) ABSTRACT

An automatic charging device is provided in the disclosure, which includes a charging assembly, a moving rail, a side conveying mechanism provided on a carrier and a cross beam provided on a parking space. The charging assembly is arranged on the moving rail, the side conveying mechanism includes a side conveying beam, a flexible conveying mechanism and a movement adjusting assembly for controlling abutting of the side conveying beam against the cross beam. The flexible conveying mechanism is provided with a first clamping piece and a second clamping piece. The moving rail is provided with a first groove and a second groove. A distance D₁ between the first clamping piece and the second clamping piece is equal to a distance D₂ between the first groove and the second groove.

### TECHNICAL FIELD

The disclosure relates to the technical field of parking equipment, in particular to an automatic charging device and a roller-table parking equipment.

### BACKGROUND ART

In recent years, with increasing demand for new energy vehicles, parking lots generally are required to be equipped with a certain proportion of charging parking spaces. Generally, it is recommended to provide a charging station on ground plane parking spaces, but there's no plane parking space or no enough plane parking space at many sites, which requires the charging station to be arranged in a mechanical parking space. In a case of a roller-table intelligent parking garage not being provided with the charging parking space, other types of parking space can only be adopted instead, such as comb parking equipment, but there is a problem of reduced parking spaces.

### SUMMARY

In view of above problems, an automatic charging device suitable for roller-table parking equipment and roller-table parking equipment with the automatic charging device are provided in this disclosure.

Technical schemes adopted by the disclosure are as follows. An automatic charging device is provided in the disclosure, which is arranged on a carrier and a parking space. The automatic charging device includes a charging assembly, a moving rail, a side conveying mechanism provided on a carrier and a cross beam provided on a parking space. The charging assembly is arranged on the moving rail, the side conveying mechanism includes a side conveying beam, a flexible conveying mechanism and a movement adjusting assembly for controlling abutting of the side conveying beam against the cross beam. The moving rail is in sliding fit with both the side conveying beam and the cross beam. The flexible conveying mechanism is provided with a first clamping piece and a second clamping piece. The moving rail is provided with a first groove and a second groove. A distance D₁ between the first clamping piece and the second clamping piece is equal to a distance D₂ between the first groove and the second groove.

The cross beam and the side conveying beam have a same structure, so that the moving rail can smoothly slide back and forth between the cross beam and the side conveying beam. When the moving rail abuts against the cross beam, the side conveying beam is axially opposite to the cross beam.

Specifically, when the charging assembly is located on the carrier, the moving rail is located on the side conveying beam, and the first clamping piece and the second clamping piece on the flexible conveying mechanism are located in the first groove and the second groove (at a first limit position) respectively. The movement adjusting assembly is configured to adjust the side conveying beam and the moving rail on the side conveying beam to approach the cross beam when the charging assembly needs to be moved from the carrier to the parking space, and then the flexible conveying mechanism is moved in a direction toward the cross beam (moved in a clockwise manner), and the first clamping piece and the second clamping piece on the flexible conveying mechanism are hooked to the first groove and the second groove respectively and to move in the direction toward the cross beam with the moving rail. With movement of the flexible conveying mechanism, the first clamping piece is removed from the first groove, the second clamping piece is hooked to the second groove to continuously push the moving rail to move in the direction toward the cross beam (at a second transmission position), and at this time, a part of the moving rail is positioned on the side conveying beam and another part of the moving rail is positioned on the cross beam. As the flexible conveying mechanism continues to moving in the direction toward the cross beam until the second clamping piece is removed from the second groove (at a third limit position), at this time, the moving rail is completely located on the cross beam, and the movement adjusting assembly serves to adjust and move the side conveying beam away from the cross beam, so that both the moving rail and the charging assembly remain on the cross beam.

When it is necessary to take the charging assembly from the parking space to the carrier, firstly the flexible conveying mechanism is adjusted to the third limit position, then the movement adjusting assembly serves to adjust and approach the side conveying beam to the cross beam, and then to move the flexible conveying mechanism away from the cross beam (to move in a counterclockwise manner). The second clamping piece is clamped into the second groove so as to drive the moving rail to move to the side conveying beam until the flexible conveying mechanism is at the first limit position and the moving rail is completely positioned on the side conveying beam.

When a next vehicle needs to be charged, a charging assembly is taken automatically by the carrier from an empty parking space to the carrier in advance.

Alternatively, the distance D₁ between the first clamping piece and the second clamping piece is not greater than a transmission distance D3 of the flexible conveying mechanism, so that the first clamping piece and the second clamping piece can be respectively removed from the first groove and the second groove during movement of the flexible conveying mechanism.

Alternatively, the distance D₂ between the first groove and the second groove is not less than a length D4 of the cross beam, so that when the charging assembly is taken from the parking space, the second clamping piece can be clamped into the second groove so as to bring the moving rail out of the cross beam.

Alternatively, the flexible conveying mechanism further includes a first transmission chain and a second transmission chain connected with each other, and both ends of the first transmission chain and both ends of the second transmission chain are respectively connected with each other through the first clamping piece and the second clamping piece. Correspondingly, the side conveying beam is provided with a transmission chain wheel engaged with the first transmission chain and the second transmission chain, and the first transmission chain and the second transmission chain can function in transmission by the transmission chain wheel engaged with them.

Specifically, the first drive chain and the second drive chain can be roller chains. The first clamping piece and the second clamping piece can be pin shafts, which can not only meet requirements of a hinging structure between the roller chains, but also cooperate with the first groove and the second groove so as to hook and move the rail. Specifically, there can be two groups of flexible conveying mechanisms provided, and the two groups of flexible conveying mechanisms are arranged in parallel and synchronously, and two pin shafts are arranged in parallel between the two groups of flexible conveying mechanisms.

Alternatively, the movement adjusting assembly includes a third transmission chain. The third transmission chain is arranged on the side conveying beam, and the side conveying mechanism further includes a support base with a chain wheel, and the third transmission chain is matched with the chain wheel of the support base for transmission. When the chain wheel on the support base rotates, it pushes the third transmission chain to move, thus driving the side conveying beam to approach or be away from the cross beam.

Alternatively, the movement adjusting assembly further includes a transmission guide wheel, which is arranged on the support base, and the side conveying beam is provided with a guide wheel groove matched with the transmission guide wheel, and the transmission guide wheel is in sliding fit with the guide wheel groove of the side conveying beam. The transmission guide wheel is in sliding fit with the side conveying beam through the guide wheel groove. The side conveying beam has two moving structures, the third drive chain and the drive guide wheel, which is more stable.

Alternatively, the side conveying beam is provided with a chain guide, and the first transmission chain and the second transmission chain are wound on the chain guide. Because an endless chain formed by joint of the first transmission chain and the second transmission chain is long and transversely arranged, the chain guide is provided to hold the chain and prevent the chain from sagging. The chain guide is made of nylon, which has high mechanical strength, smooth surface and low friction coefficient, which facilitates movement of the endless chain.

Alternatively, a chain fixing seat is provided at both ends of the third transmission chain, which can be configured to fix the chain and adjust tightness of the chain.

Alternatively, the moving rail is provided with a sliding part which is in sliding fit with the side conveying beam and the cross beam, and the sliding part is provided with a lead-in surface obliquely arranged at both ends thereof. The sliding part is made of nylon so as to reduce friction. The inclined lead-in surface facilitates smooth sliding at a joint between the side conveying beam and the cross beam.

Alternatively, the charging assembly includes a current collector, a car charger and a charging cable. The charging cable is configured to connect the current collector with the car charger. The cross beam is provided with a collector rail. The current collector is matched with the collector rail, and the collector rail is electrically connected with a power supply. When the charging assembly is moved transversely to the cross beam of the parking space, the current collector slides into the collector rail to be powered.

A side of the collector rail proximate to the side conveying beam is further provided with a lead-in plate, which can assist in joining of the collector and the collector rail.

Alternatively, the moving rail is provided with a storage box where the car charger and the charging cable can be placed.

Alternatively, the automatic charging device further includes a cord reel, and the cord reel can be configured to roll up the charging cable. Specifically, the cord reel can be of a suction structure or a magnet-type structure. After the car charger is inserted into a charging port of the car, an extra length of the charging cable is fixed to the car through the cord reel.

A roller-table parking equipment is further provided in the disclosure, which includes the automatic charging device described above. With a reducer motor and calculation of a transmission ratio, a speed at which the car is conveyed into the parking space (a side conveying speed of a roller table) is the same as that of the moving rail and the charging assembly on the moving rail, which ensures that a relative position of the charging cable to the car will not change.

The automatic charging device provided by the disclosure has beneficial effect that the automatic charging device can be suitable for the roller-table parking equipment. When parking and charging are needed, a charging assembly can be taken by the carrier from an empty parking space in advance, and a driver can directly take the charging assembly from the carrier to charge the car, which is more convenient for charging. After parking and charging in place, the carrier is moved to the empty parking space described above, and the car and charging assembly can be moved to the parking space synchronously.

### BRIEF DESCRIPTION OF THE DRAWINGS

FIG. 1 is a schematic structural view of a charging assembly and a moving rail located on a side conveying mechanism according to an embodiment of the present disclosure;

FIG. 2 is a side view of a charging assembly and a moving rail located on a side conveying mechanism according to an embodiment of the present disclosure;

FIG. 3 is a schematic structural view of a collector rail located on a cross beam according to an embodiment of the present disclosure;

FIG. 4 is a schematic structural view of a transmission guide wheel provided on a support base according to an embodiment of the present disclosure;

FIG. 5 is a side view of a transmission guide wheel provided on a support base according to an embodiment of the present disclosure;

FIG. 6 is a schematic structural view of a side conveying beam according to an embodiment of the present disclosure;

FIG. 7 is a top view of a side conveying beam according to an embodiment of the present disclosure;

FIG. 8 is a side view of a side conveying beam according to an embodiment of the present disclosure;

FIG. 9 is a schematic structural view of a flexible conveying mechanism according to an embodiment of the present disclosure;

FIG. 10 is a top view of a flexible conveying mechanism according to an embodiment of the present disclosure;

FIG. 11 is a schematic structural view of a charging assembly and a moving rail according to an embodiment of the present disclosure;

FIG. 12 is a side view of a charging assembly and a moving rail according to an embodiment of the present disclosure;

FIG. 13 is a side view of a collector rail located on a cross beam according to an embodiment of the present disclosure;

FIG. 14 is a structural schematic view at a first limit position according to an embodiment of the present disclosure;

FIG. 15 is a schematic structural view at a first limit position with a side conveying beam abutting against the cross beam according to an embodiment of the present disclosure;

FIG. 16 is a structural schematic view at a second transmission position according to an embodiment of the present disclosure;

FIG. 17 is a structural schematic view at a third transmission position according to an embodiment of the present disclosure; and

FIG. 18 is a structural schematic view of a roller-table parking equipment according to an embodiment of the present disclosure.

Reference numbers in the figures are as follows: 1. Charging Assembly; 2. Moving Rail; 3. Side Conveying Mechanism; 4. Cross Beam; 11. Current Collector; 12. Car Charger; 13. Charging Cable; 14. Collector Rail; 15. Lead-in Plate; 16. Cord Reel; 17. Power Supply Line; 18. Storage Box; 21. Sliding Part; 22. Lead-in Surface; 23. First Groove; 24. Second Groove; 31, Side Conveying Beam; 32. Flexible Conveying Mechanism; 33. Movement Adjusting Assembly; 34. Transmission Chain Wheel; 35. Support Base; 36, Chain Wheel; 311, Guide Wheel Groove; 312, Chain Guide; 321. First Clamping Piece; 322. Second Clamping Piece; 323. First Transmission Chain; 324, Second Transmission Chain; 331, Third Transmission Chain; 332, Transmission Guide Wheel; 333. Chain Fixing Seat; 101, Carrier; 102. Parking Space;
D₁ is a distance between the first clamping piece and the second clamping piece; D₂ is a distance between the first groove and the second groove; D₃ is a transmission distance of the flexible conveying mechanism; and D₄ is a length of the beam.

### DETAILED DESCRIPTION

In the following, a detailed and complete description of the present disclosure will be made in combination with specific embodiments with reference to the drawings.

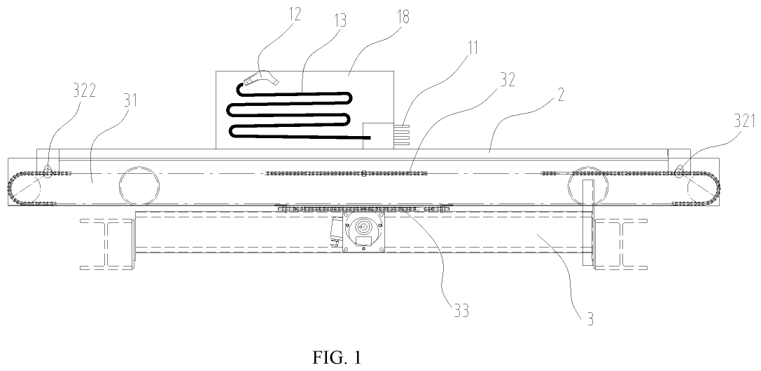

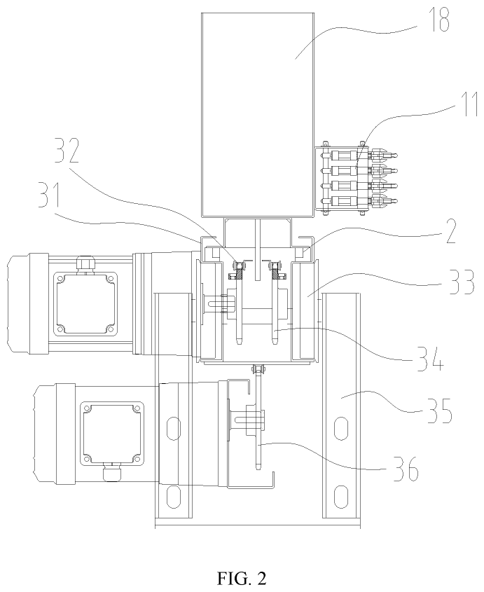

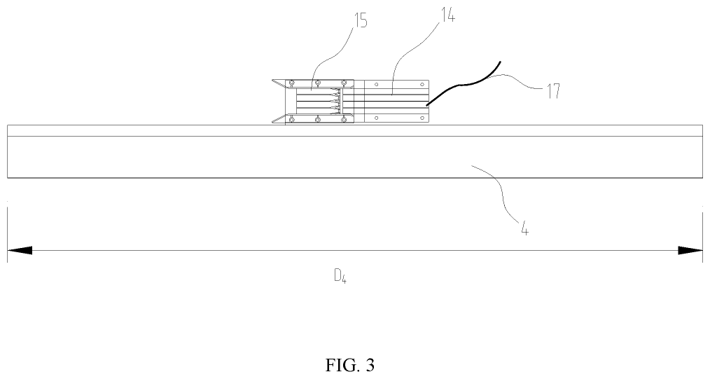

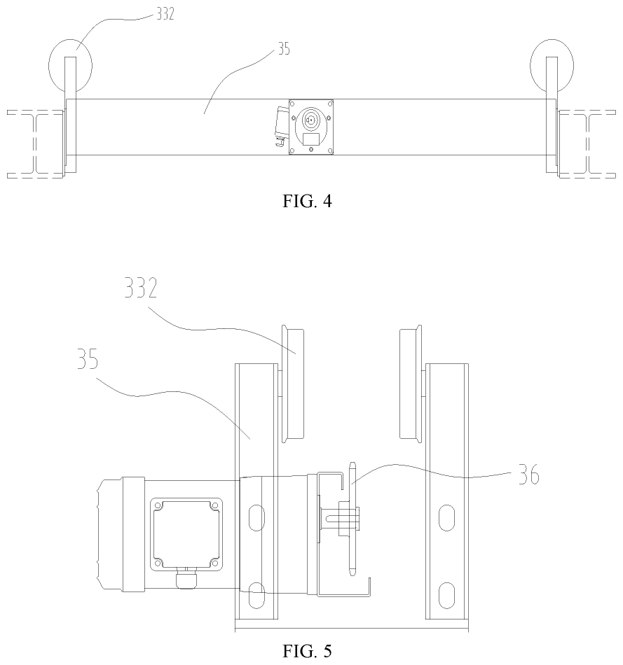

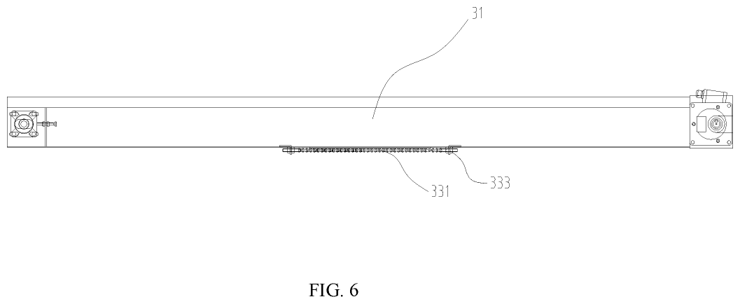

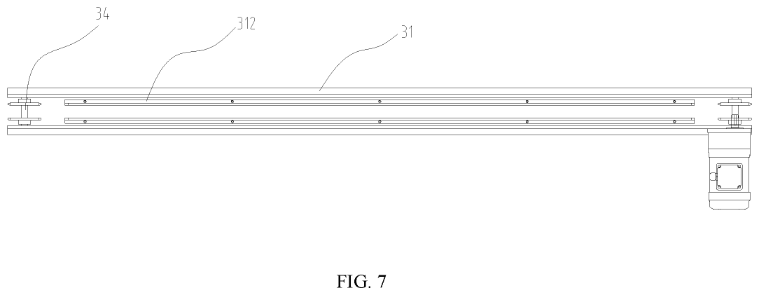

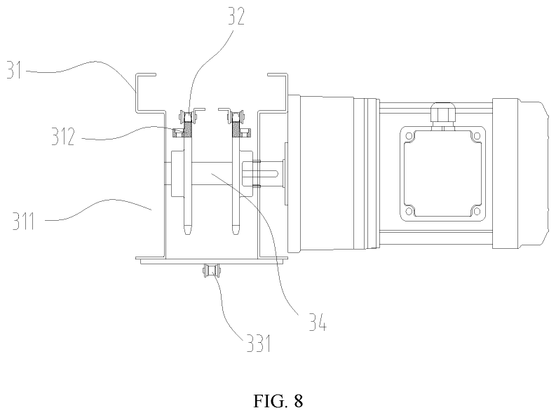

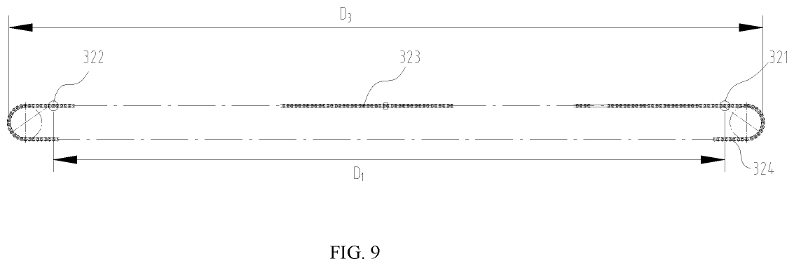

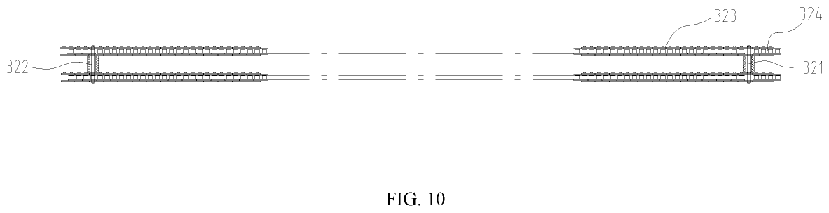

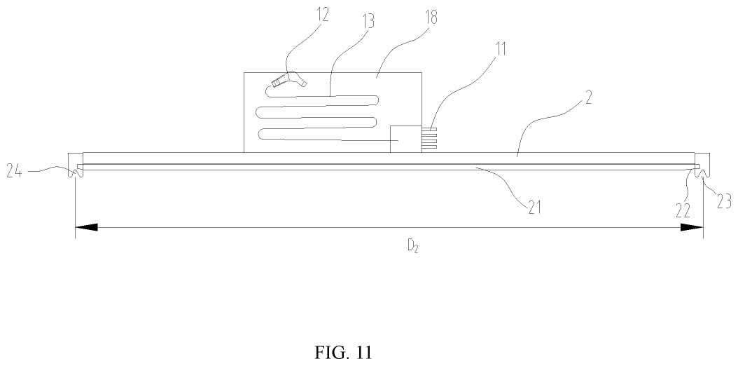

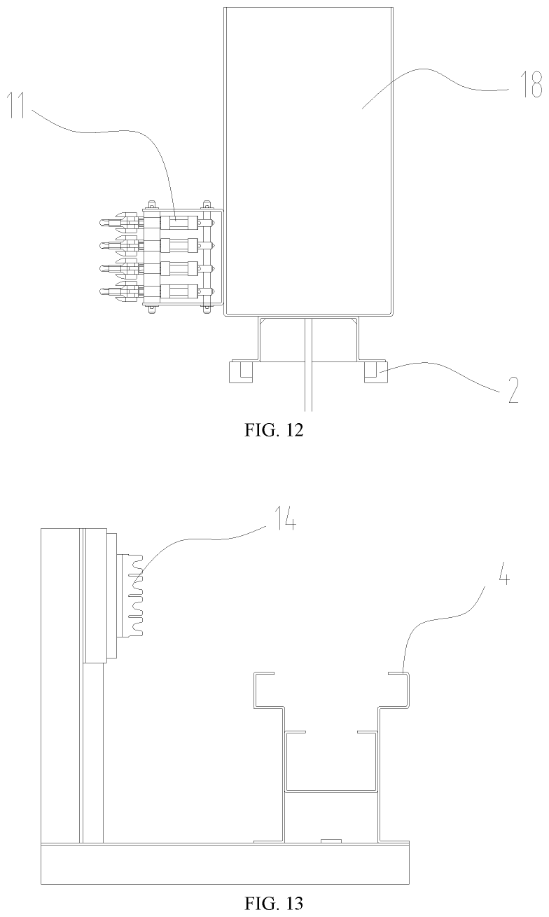

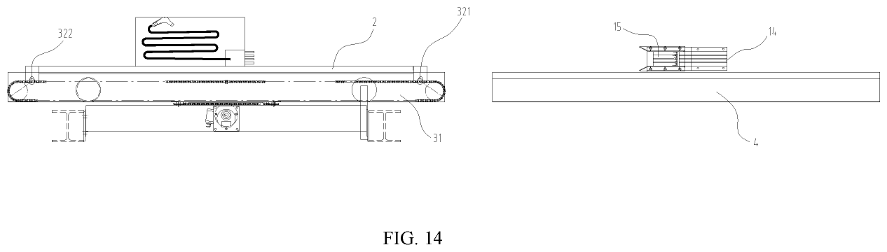

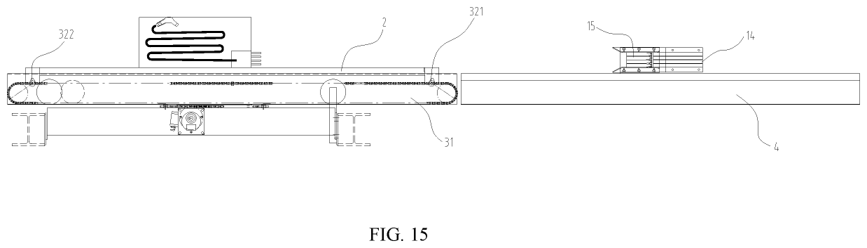

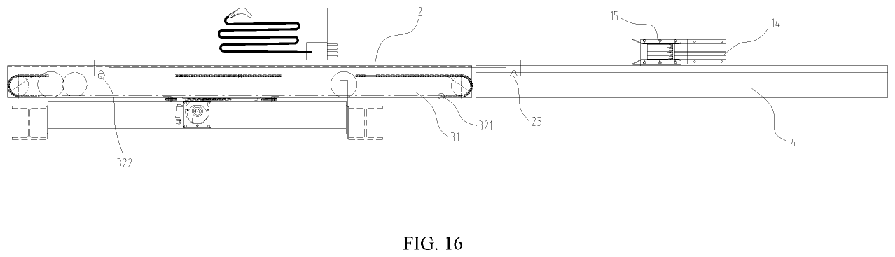

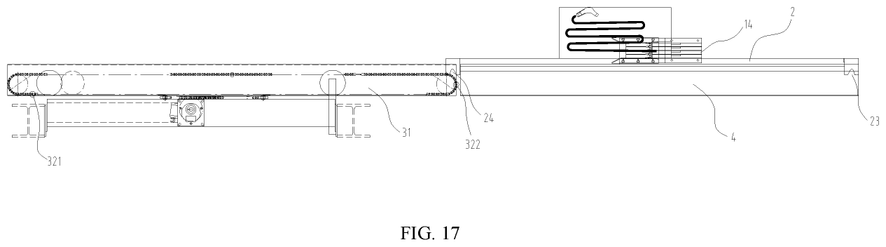

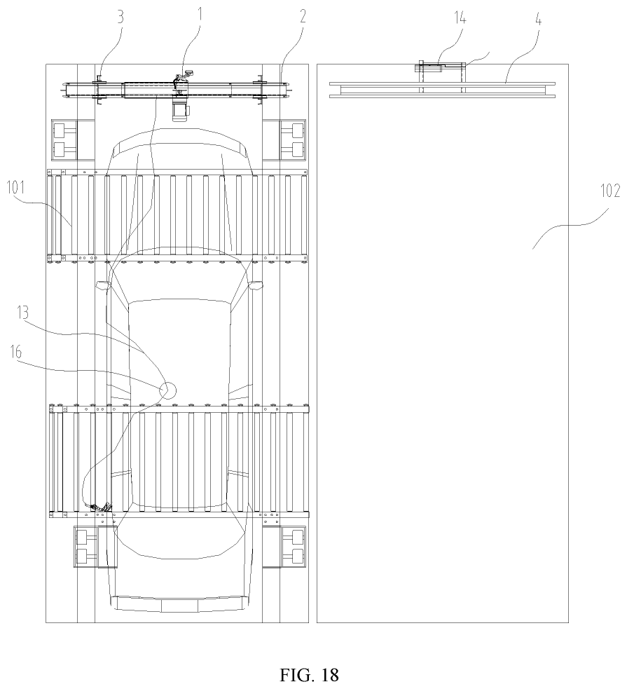

Referring to FIGS. 1-18, an automatic charging device is provided in the disclosure, which is arranged on a carrier 101 and a parking space 102. The automatic charging device includes a charging assembly 1, a moving rail 2, a side conveying mechanism 3 arranged on a carrier 101, and a cross beam 4 arranged on a parking space 102. The charging assembly 1 is arranged on the moving rail 2.

The charging assembly 1 includes a current collector 11, a car charger 12 and a charging cable 13. The charging cable 13 is configured to connect the current collector 11 with the car charger 12. The cross beam 4 is provided with a collector rail 14 electrically connected with a power supply through a power supply line 17. A side of the collector rail 14 proximate to the side conveying beam 31 is further provided with an lead-in plate 15, which can assist in joining of the current collector 11 and the collector rail 14. When the charging assembly 1 is moved transversely to the cross beam 4 of the parking space 102, the current collector 11 slides into the collector rail 14 to be powered.

The side conveying mechanism 3 includes a side conveying beam 31, a flexible conveying mechanism 32, and a movement adjusting assembly 33 for controlling abutting of the side conveying beam 31 against the cross beam 4. The moving rail 2 is in sliding fit with both the side conveying beam 31 and the cross beam 4, and the cross beam 4 and the side conveying beam 31 have a same structure, so that the moving rail 2 can smoothly slide back and forth between the cross beam 4 and the side conveying beam 31.

The moving rail 2 is provided with a sliding part 21 which is in sliding fit with the side conveying beam 31 and the cross beam 4. The sliding part 21 is made of nylon, and the sliding part 21 is provided with a lead-in surface 22 obliquely arranged at both ends thereof, so as to smoothly slide at a joint between the side conveying beam 31 and the cross beam 4.

The flexible conveying mechanism 32 is provided with a first clamping piece 321, a second clamping piece 322, and a first transmission chain 323 and a second transmission chain 324 connected with each other. Both ends of the first transmission chain 323 and both ends of the second transmission chain 324 are respectively connected with each other through the first clamping piece 321 and the second clamping piece 322. The moving rail 2 is provided with a first groove 23 and a second groove 24. Correspondingly, the side conveying beam 31 is provided with a transmission chain wheel 34 engaged with the first transmission chain 323 and the second transmission chain 324, and the first transmission chain 323 and the second transmission chain 324 can function in transmission by the transmission chain wheel 34 engaged with them.

A distance D₁ between the first clamping piece 321 and the second clamping piece 322 is equal to a distance D₂ between the first groove 23 and the second groove 24. A transmission distance D₃ of the flexible conveying mechanism 32 is greater than the distance D₁ between the first clamping piece 321 and the second clamping piece 322, so that during movement of the flexible conveying mechanism 32, the first clamping piece 321 and the second clamping piece 322 can be removed from the first groove 23 and the second groove 24 respectively. The distance D₂ between the first groove 23 and the second groove 24 is not less than a length D₄ of the cross beam 4, so that when the charging assembly 1 is taken from the parking space 102, the second clamping piece 322 can be clamped into the second groove 24, so as to bring the moving rail 2 out of the cross beam 4.

The movement adjusting assembly 33 includes a third transmission chain 331 and a transmission guide wheel 332. The side conveying mechanism 3 further includes a support base 35 with a chain wheel 36, and a driving guide wheel 332 is arranged on the support base 35. The third transmission chain 331 is arranged on the side conveying beam 31, and the third transmission chain 331 is matched with the chain wheel 36 of the support base 35 for transmission. The side conveying beam 31 is provided with a guide wheel groove 311 matched with the transmission guide wheel 332, and the transmission guide wheel 332 is in sliding fit with the guide wheel groove 311 of the side conveying beam 31.

The side conveying beam 31 is provided with a chain guide 312 made of nylon, and the first transmission chain 323 and the second transmission chain 324 are wound on the chain guide 312, and the chain guide is provided to hold the chain and prevent the chain from sagging. A chain fixing seat 333 is provided at both ends of the third transmission chain 331, which can be configured to fix the chain and adjust tightness of the chain.

The moving rail 2 is provided with a storage box 18 where the car charger 12 and the charging cable 13 can be placed.

The automatic charging device further includes a cord reel 16 with a suction structure or a magnet-type structure, and the cord reel 16 can be configured to roll up the charging cable 13. After the car charger 12 is inserted into a charging port of the car, an extra length of the charging cable 13 is fixed to the car through the cord reel 16.

Its working principle is as follows: in a first limit position, the charging assembly 1 is located on the carrier 101, the moving rail 2 is located on the side conveying beam 31, and the first clamping piece 321 and the second clamping piece 322 on the flexible conveying mechanism 32 are located in the first groove 23 and the second groove 24 respectively. The movement adjusting assembly 33 is configured to adjust the side conveying beam 31 and the moving rail 2 on the side conveying beam 31 to approach the cross beam 4 when the charging assembly 1 needs to be moved from the carrier 101 to the parking space 102, and then the flexible conveying mechanism 32 is moved in a direction toward the cross beam 4 (moved in a clockwise manner), and the first clamping piece 321 and the second clamping piece 322 on the flexible conveying mechanism 32 are clamped to the first groove 23 and the second groove 24 respectively and to move in the direction toward the cross beam 4 with the moving rail 2. With movement of the flexible conveying mechanism 32 to a second transmission position, the first clamping piece 321 is removed from the first groove 23, the second clamping piece 322 acts on the second groove 24 to continuously push the moving rail 2 to move in the direction toward the cross beam 4, and at this time, a part of the moving rail 2 is positioned on the side conveying beam 31 and another part of the moving rail is positioned on the cross beam 4. As the flexible conveying mechanism 32 continues to moving in the direction toward the cross beam 4 to a third limit position and the second clamping piece 322 is removed from the second groove 24, at this time, the moving rail 2 is completely located on the cross beam 4, and the movement adjusting assembly 33 serves to adjust and move the side conveying beam 31 away from the cross beam 4, so that both the moving rail 2 and the charging assembly 1 remain on the cross beam 4.

When it is necessary to take the charging assembly 1 from the parking space 102 to the carrier 101, firstly the flexible conveying mechanism 32 is adjusted to the third limit position, then the movement adjusting assembly 33 serves to adjust and approach the side conveying beam 31 to the cross beam 4, and then to move the flexible conveying mechanism 32 away from the cross beam 4 (to move in a counterclockwise manner). The second clamping piece 322 is clamped into the second groove so as to drive the moving rail 2 to move to the side conveying beam 31 until the flexible conveying mechanism 32 is at the first limit position and the moving rail 2 is completely positioned on the side conveying beam 31. When the vehicle needs to be charged, a charging assembly 1 is taken automatically by the carrier 101 from an empty parking space 102 in advance.

Referring to FIGS. 1 to 18, a roller-table parking equipment is further provided in the disclosure, which includes the automatic charging device described above. With a reducer motor and calculation of a transmission ratio, a speed at which the car is conveyed into the parking space 102 (a side conveying speed of a roller table) is the same as that of the moving rail 2 and the charging assembly 1 on the moving rail 2, which ensures that a relative position of the charging cable 13 to the car will not change.

The above is only preferred embodiments of the present disclosure, which does not limit a protection scope of the present disclosure. Any equivalent transformation made with the specification of the present disclosure, which is directly or indirectly applied to other related technical fields, is included within the scope of the disclosure.

1. An automatic charging device provided on a carrier and a parking space, comprising a charging assembly, a moving rail, a side conveying mechanism provided on a carrier and a cross beam provided on a parking space, wherein the charging assembly is arranged on the moving rail, the side conveying mechanism comprises a side conveying beam, a flexible conveying mechanism and a movement adjusting assembly for controlling abutting of the side conveying beam against the cross beam, the side conveying beam and the cross beam have a same structure, the moving rail is in sliding fit with both the side conveying beam and the cross beam, the flexible conveying mechanism is provided with a first clamping piece and a second clamping piece, the moving rail is provided with a first groove and a second groove, a distance D₁ between the first clamping piece and the second clamping piece being equal to a distance D₂ between the first groove and the second groove;
at a first limit position, the first clamping piece and the second clamping piece are respectively hooked to and matched with the first groove and the second groove, and the moving rail is located on the side conveying beam;
at a second transmission position, the first clamping piece is removed from the first groove, the second clamping piece is hooked to and matched with the second groove, and the moving rail is located on the side conveying beam and the cross beam; and
at a third limit position, the first clamping piece and the second clamping piece respectively are removed from the first groove and the second groove, and the moving rail is located on the cross beam.

2. The automatic charging device according to claim 1, wherein the distance D₁ between the first clamping piece and the second clamping piece is not greater than a transmission distance D₃ of the flexible conveying mechanism; and
the distance D₂ between the first groove and the second groove is not less than a length D₄ of the cross beam.

3. The automatic charging device according to claim 1, wherein the flexible conveying mechanism further comprises a first transmission chain and a second transmission chain connected with each other, and both ends of the first transmission chain and both ends of the second transmission chain being respectively connected with each other through the first clamping piece and the second clamping piece.

4. The automatic charging device according to claim 3, wherein the movement adjusting assembly comprises a third transmission chain, the third transmission chain being arranged on the side conveying beam, and the side conveying mechanism further comprises a support base with a chain wheel, the third transmission chain being matched with the chain wheel of the support base for transmission.

5. The automatic charging device according to claim 4, wherein the movement adjusting assembly further comprises a transmission guide wheel, which is arranged on the support base, and the side conveying beam is provided with a guide wheel groove matched with the transmission guide wheel, the transmission guide wheel being in sliding fit with the guide wheel groove of the side conveying beam.

6. The automatic charging device according to claim 4, wherein the side conveying beam is provided with a chain guide, and the first transmission chain and the second transmission chain are wound on the chain guide; and
a chain fixing seat for fixing the chain and adjusting tightness of the chain is provided at both ends of the third transmission chain.

7. The automatic charging device according to claim 1, wherein the moving rail is provided with a sliding part which is in sliding fit with the side conveying beam and the cross beam, the sliding part being provided with a lead-in surface obliquely arranged at both ends thereof.

8. The automatic charging device according to claim 4, wherein the charging assembly comprises a current collector, a car charger and a charging cable, the charging cable being configured to connect the current collector with the car charger; the cross beam is provided with a collector rail, the current collector being matched with the collector rail and the collector rail being electrically connected with a power supply.

9. The automatic charging device according to claim 8, wherein the moving rail is provided with a storage box for placing the car charger and the charging cable; and
the automatic charging device further comprises a cord reel for rolling up the charging cable.

10. The automatic charging device according to claim 2, wherein the flexible conveying mechanism further comprises a first transmission chain and a second transmission chain connected with each other, and both ends of the first transmission chain and both ends of the second transmission chain being respectively connected with each other through the first clamping piece and the second clamping piece.

11. The automatic charging device according to claim 10, wherein the movement adjusting assembly comprises a third transmission chain, the third transmission chain being arranged on the side conveying beam, and the side conveying mechanism further comprises a support base with a chain wheel, the third transmission chain being matched with the chain wheel of the support base for transmission.

12. The automatic charging device according to claim 11, wherein the movement adjusting assembly further comprises a transmission guide wheel, which is arranged on the support base, and the side conveying beam is provided with a guide wheel groove matched with the transmission guide wheel, the transmission guide wheel being in sliding fit with the guide wheel groove of the side conveying beam.

13. The automatic charging device according to claim 11, wherein the side conveying beam is provided with a chain guide, and the first transmission chain and the second transmission chain are wound on the chain guide; and
a chain fixing seat for fixing the chain and adjusting tightness of the chain is provided at both ends of the third transmission chain.

14. The automatic charging device according to claim 11, wherein the charging assembly comprises a current collector, a car charger and a charging cable, the charging cable being configured to connect the current collector with the car charger; the cross beam is provided with a collector rail, the current collector being matched with the collector rail and the collector rail being electrically connected with a power supply.

15. The automatic charging device according to claim 14, wherein the moving rail is provided with a storage box for placing the car charger and the charging cable; and
the automatic charging device further comprises a cord reel for rolling up the charging cable.

16. A roller-table parking equipment, comprising the automatic charging device according to claim 1.
